(19) United States
(12) Patent Application Publication
(10) Pub. No.: US 2023/0068557 A1
(43) Pub. Date: Mar. 2, 2023

(54) ELECTRIC SELF-STEER WAGON TRAILER

(71) Applicant: The SMART Wagon Corporation, Paris, TX (US)

(72) Inventors: Pike Burkhart, Paris, TX (US); Pike Burkhart, Dallas, TX (US)

(21) Appl. No.: 17/896,906

(22) Filed: Aug. 26, 2022

Related U.S. Application Data
(60) Provisional application No. 63/237,599, filed on Aug. 27, 2021.

(51) Int. Cl. B62D 13/04; B62D 59/04

(52) U.S. Cl. CPC B62D 13/04; B62D 59/04

(57) ABSTRACT

Electric, self-steer wagon-trailers may be provided. A trailer-to-tow vehicle electric, power-sharing booster system may extend the towing electric vehicle (EV) battery life/travel range. A high voltage, battery module recharge system may be provided that is compatible with standard, electric grid EV recharge connectors. A wagon style, highway speed, self-steer front axle system may eliminate trailer-to-vehicle vertical hitch load on the tow vehicle, which increases trailer and tow vehicle stability thus, increasing towing efficiencies and safety.

### CROSS-REFERENCE TO RELATED APPLICATION

The present Application is a non-provisional of, and claims priority to, U.S. Patent Application No. 63/237,599 filed Aug. 27, 2021, the disclosure of which is incorporated by reference in its entirety.

### FIELD OF THE DISCLOSURE

The present disclosure generally relates to electric self-steer wagon trailers, and more particularly to a trailer-to-tow vehicle, electric, power-sharing, rechargeable booster system for a self-steer wagon trailer to increase the electric vehicle (EV) range by the EV borrowing power stored in the trailer's electric power module and also by the EV using propulsion momentum generated by the trailer's electric rear axle.

### BACKGROUND

Electric Vehicles (EVs) are at the forefront of emerging automotive technology with many makers launching new vehicles now and in the future. The biggest challenge facing electric vehicles is battery life. Hence, increasing battery life, providing vehicle range boosters, and/or decreasing recharge time are of primary importance. Towing a trailer with an EV offers its own set of challenges to maximizing driving range. Recharging means can be an issue. Tow vehicle and trailer weight also are other issues along with negative aerodynamics power draw and combination vehicle high speed stability. Conventional trailer designs suffer the shortcomings in handling highway crosswinds, hitch weight, and general poor weight distribution due to their three-point stance.

### SUMMARY

Embodiments of the present disclosure may provide electric, self-steer wagon-trailers, and more particularly, the combination of design features disclosed herein such as a trailer-to-tow vehicle electric, power-sharing booster system to extend the towing electric vehicle (EV) battery life/travel range, a high voltage, battery module recharge system compatible with standard, electric grid EV recharge connectors, and/or a wagon style, highway speed, self-steer front axle system that eliminates trailer-to-vehicle vertical hitch load on the tow vehicle, which increases trailer and tow vehicle stability thus, increasing towing efficiencies and safety as described in U.S. Pat. No. 9,315,211.

Embodiments of the present disclosure also may provide an electric, self-steer wagon-trailer comprising: a first sub-assembly having a wagon chassis with an automotive, C-channel style frame; a second sub-assembly having a front self-steering axle and an electrical control system and recharge system that may be capable of controlling, charging, and/or stowing power in a battery pack module that may power a shared electric power booster system, the second sub-assembly installed in the C-channel style frame of the first sub-assembly; and a third sub-assembly that provides a bolt-on-body after completion and installation of the first and second sub-assemblies. The C-channel style frame of the first sub-assembly also may include axles, tires, and wheels. The second sub-assembly also may include an electric propulsion rear axle and power for lighting for highway operation of the wagon-trailer and its off-highway, autonomous operations. The battery pack module may be electronically controlled. The second sub-assembly also may include electric regenerative braking on a rear axle, a front axle, or both; a power generating wheel hub on a rear axle, a front axle, or both; and/or an electronically controlled propulsion control module. The battery pack module may provide power to a plurality of 12-volt motors and electrical components. 12/24 Volt DC regeneration systems of a combination vehicle of a tow vehicle and the wagon-trailer may charge the battery pack module on the tow vehicle and/or on the wagon-trailer when in transit. A stationary charging system may convert 120 volts AC to 12-volt DC to charge the battery pack module when a combination vehicle of a tow vehicle and the wagon-trailer is stationary. The wagon-trailer also may include a plurality of solar energy panels mounted on a roof of the wagon-trailer to recharge the battery pack module when a combination vehicle of a tow vehicle and the wagon-trailer is stationary or in transit.

Other embodiments of the present disclosure may provide an electric, self-steer wagon-trailer comprising: a first sub-assembly having a wagon chassis with an automotive, C-channel style frame; a second sub-assembly comprising: a front self-steering axle; electric regenerative braking on a rear axle, a front axle, or both; a power generating wheel hub on a rear axle, a front axle, or both; and an electrical control system and recharge system that may be capable of controlling, charging, and/or stowing power in a battery pack module that powers a shared electric power booster system, the second sub-assembly installed in the C-channel style frame of the first sub-assembly; and a third sub-assembly that may provide a bolt-on-body after completion and installation of the first and second sub-assemblies. The second sub-assembly also may include an electric propulsion rear axle and power for lighting for highway operation of the wagon-trailer and its off-highway, autonomous operations. The battery pack module may be electronically controlled. The second sub-assembly may further include an electronically controlled propulsion control module. The battery pack module may provide power to a plurality of 12-volt motors and electrical components. 12/24 Volt DC regeneration systems of a combination vehicle of a tow vehicle and the wagon-trailer may charge the battery pack module on the tow vehicle and/or on the wagon-trailer when in transit. A stationary charging system may convert 120 volts AC to 12-volt DC charges the battery pack module when a combination vehicle of a tow vehicle and the wagon-trailer is stationary. The wagon-trailer may include a plurality of solar energy panels mounted on a roof of the wagon-trailer to recharge the battery pack module when a combination vehicle of a tow vehicle and the wagon-trailer is stationary or in transit.

### BRIEF DESCRIPTION OF THE DRAWINGS

For a more complete understanding of this disclosure, reference is now made to the following description, taken in conjunction with the accompanying drawings, in which:

FIG. 1 depicts a first sub-assembly of an electric wagon-trailer according to an embodiment of the present disclosure;

FIG. 2 depicts a second sub-assembly of an electric wagon-trailer according to an embodiment of the present disclosure; and

FIG. 3 depicts a third sub-assembly of an electric wagon-trailer according to an embodiment of the present disclosure.

### DETAILED DESCRIPTION

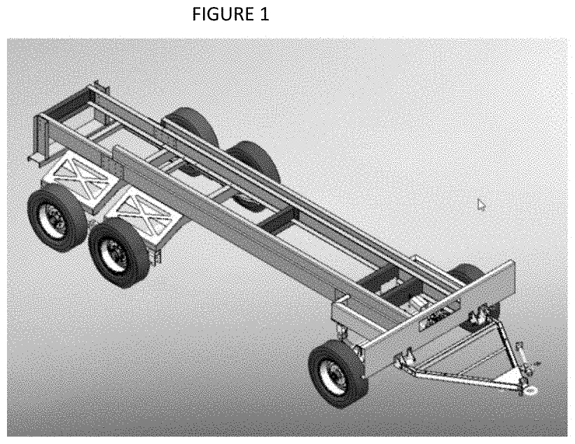

Embodiments of the present disclosure may provide an electric wagon-trailer having three main sub-assemblies. A first sub-assembly (FIG. 1) may include a wagon chassis having an automotive, C-channel style frame with axles, tires, and/or wheels into which the items in the second sub-assembly will be installed.

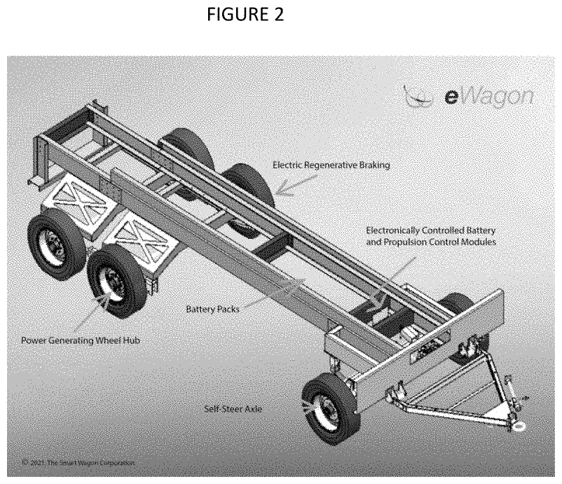

A second sub-assembly (FIG. 2) may provide an electrical control system and recharge system that may control/charge and/or stow power in a battery pack module that may power the shared electric power booster system. The second sub-assembly also may include an electric propulsion rear axle and power for required lighting for highway operation of the wagon-trailer and its off-highway, autonomous operations. FIG. 2 depicts inclusion of electric regenerative braking, electronically controlled battery and propulsion control modules, battery packs, and a power generating wheel hub.

Remotely charging a battery pack on a trailer by running a charge wire from the tow vehicle's alternator charging system has been in the RV industry. This trailer battery pack provides power to multiple 12-volt motors and electrical components that run various pieces of vital equipment like electric toilets, water pumps for potable water, fans, lights, etc. In embodiments of the present disclosure, the combination vehicle (tow vehicle and wagon style trailer) could charge the trailer's battery pack with the 12/24 Volt DC regeneration systems on the tow vehicle and on the wagon when on the move and also plug into a stationary charging system that converts 120 volts AC to 12-volt DC and charges up the tow vehicle and wagon battery packs simultaneously when the combination vehicle is stationary. In some embodiments of the present disclosure, solar energy panels could be roof mounted on the wagon trailer and contribute their energy to help in the recharge process whether combination vehicle is stationary, or on the move.

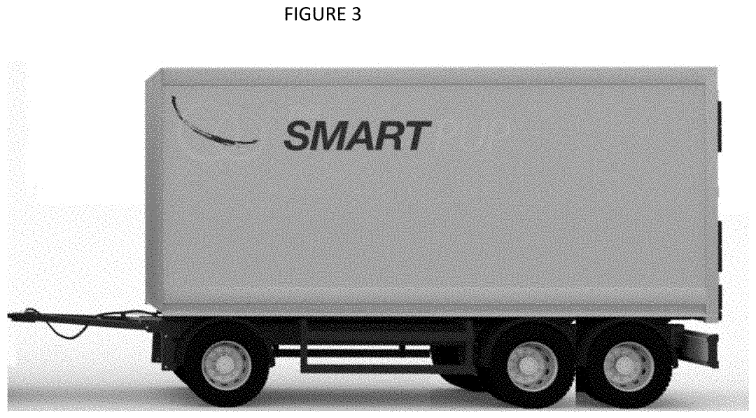

A third sub-assembly (FIG. 3) may provide a bolt-on-body after completion and installation of the first and second sub-assemblies. Final installation of an industry standard, or a custom body design, to fit the wagon-trailer's industry standard (or custom) frame widths and body configurations for form (aerodynamics) and intended functions. This arrangement may produce a local and regional use, zero emissions/carbon neutral, highway speed towing, self-steering, slow speed self-propelled capable, power generating wagon-trailer with remote controlled, semi-autonomous operational capabilities in a controlled yard or warehouse environment.

An electric self-steer wagon trailer according to embodiments of the present disclosure may provide battery life/vehicle range boosters, improvement in recharging means and time required to recharge, management of tow vehicle and trailer weight, negative aerodynamics power draw, combination vehicle high speed stability, and/or positive means to address each of these improvements. The patented front self-steering axle used in this wagon-trailer design may minimize the effects of its additional weight and power draw on the towing EV by eliminating its hitch weight on the EV. Accordingly, it may help to solve weight challenges on its own and add resistance to high-speed towing crosswinds and general instability of 3-point weight distribution of conventional trailer designs. In addition, when the self-steering axle advantages are combined with the electric axle propulsion forces and power generating capabilities outlined herein, energy efficiencies and safety increases can be obtained.

The electric wagon-trailer according to embodiments of the present disclosure may allow transporters of goods to maximize Gross Combination Weight Ratings of truck and trailer to achieve the best of load maximization and driving range. With the self-steering axle on the front of the trailer and the addition of an electric power generating/propulsion on the rear axle, front axle, or both, this combination of components, built into road-ready Smart Wagon-Trailer Chassis, may offer users more load/delivery flexibility while enjoying the benefits and efficiencies that the electric truck market will provide for sustainable, non-polluting transportation of goods and services. The Electric Wagon-Trailer chassis will be offered complete and ready for the customer's choice of body from multiple body manufacturers specializing in transportation equipment.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An electric, self-steer wagon-trailer comprising:
a first sub-assembly having a wagon chassis with an automotive, C-channel style frame;
a second sub-assembly having a front self-steering axle and an electrical control system and recharge system that is capable of controlling, charging, and/or stowing power in a battery pack module that powers a shared electric power booster system, the second sub-assembly installed in the C-channel style frame of the first sub-assembly; and
a third sub-assembly that provides a bolt-on-body after completion and installation of the first and second sub-assemblies.

2. The wagon-trailer of claim 1, the C-channel style frame of the first sub-assembly further comprising:
axles, tires, and wheels.

3. The wagon-trailer of claim 1, the second sub-assembly further comprising:
an electric propulsion rear axle and power for lighting for highway operation of the wagon-trailer and its off-highway, autonomous operations.

4. The wagon-trailer of claim 1, wherein the battery pack module is electronically controlled.

5. The wagon-trailer of claim 1, the second sub-assembly further comprising:
electric regenerative braking on a rear axle, a front axle, or both.

6. The wagon-trailer of claim 1, the second sub-assembly further comprising:
a power generating wheel hub on a rear axle, a front axle, or both.

7. The wagon-trailer of claim 1, the second sub-assembly further comprising:
an electronically controlled propulsion control module.

8. The wagon-trailer of claim 1, wherein the battery pack module provides power to a plurality of 12-volt motors and electrical components.

9. The wagon-trailer of claim 1, wherein 12/24 Volt DC regeneration systems of a combination vehicle of a tow vehicle and the wagon-trailer charge the battery pack module on the tow vehicle and/or on the wagon-trailer when in transit.

10. The wagon-trailer of claim 1, wherein a stationary charging system converts 120 volts AC to 12-volt DC to charge the battery pack module when a combination vehicle of a tow vehicle and the wagon-trailer is stationary.

11. The wagon-trailer of claim 1 further comprising:
a plurality of solar energy panels mounted on a roof of the wagon-trailer to recharge the battery pack module when a combination vehicle of a tow vehicle and the wagon-trailer is stationary or in transit.

12. An electric, self-steer wagon-trailer comprising:
a first sub-assembly having a wagon chassis with an automotive, C-channel style frame;
a second sub-assembly comprising:
a front self-steering axle;
electric regenerative braking on a rear axle, a front axle, or both;
a power generating wheel hub on a rear axle, a front axle, or both; and
an electrical control system and recharge system that is capable of controlling, charging, and/or stowing power in a battery pack module that powers a shared electric power booster system, the second sub-assembly installed in the C-channel style frame of the first sub-assembly; and
a third sub-assembly that provides a bolt-on-body after completion and installation of the first and second sub-assemblies.

13. The wagon-trailer of claim 12, the second sub-assembly further comprising:
an electric propulsion rear axle and power for lighting for highway operation of the wagon-trailer and its off-highway, autonomous operations.

14. The wagon-trailer of claim 12, wherein the battery pack module is electronically controlled.

15. The wagon-trailer of claim 12, the second sub-assembly further comprising:
an electronically controlled propulsion control module.

16. The wagon-trailer of claim 12, wherein the battery pack module provides power to a plurality of 12-volt motors and electrical components.

17. The wagon-trailer of claim 12, wherein 12/24 Volt DC regeneration systems of a combination vehicle of a tow vehicle and the wagon-trailer charge the battery pack module on the tow vehicle and/or on the wagon-trailer when in transit.

18. The wagon-trailer of claim 12, wherein a stationary charging system converts 120 volts AC to 12-volt DC charges the battery pack module when a combination vehicle of a tow vehicle and the wagon-trailer is stationary.

19. The wagon-trailer of claim 12 further comprising:
a plurality of solar energy panels mounted on a roof of the wagon-trailer to recharge the battery pack module when a combination vehicle of a tow vehicle and the wagon-trailer is stationary or in transit.
